(19) United States
(12) Patent Application Publication
(10) Pub. No.: US 2026/0316500 A1
(43) Pub. Date: Oct. 15, 2026

(54) Trailer Jack Spacer

(71) Applicant: Caidan Carroll, Vista, CA (US)

(72) Inventor: Michael Patrick Carroll, Vista, CA (US)

(21) Appl. No.: 19/177,454

(22) Filed: Apr. 11, 2025

(51) Int. Cl. B60D 1/58; B60S 9/04

(52) U.S. Cl. CPC B60D 1/58; B60S 9/04

(57) ABSTRACT

The present invention is a device that is a spacer for relocating a trailer jack upward relative to its original mounting location, therefore providing additional ground clearance. The additional ground clearance reduces the likelihood of the jack and/or jack leg to be damaged from scraping the pavement during travel.

### FIELD OF THE INVENTION

This invention relates to trailer jacks for trailers. To be more specific, the present application relates to a device for elevating the mounting location of a trailer jack on a trailer frame, in particular a device for spacing the trailer jack upwards to increase the clearance between the jack and the ground.

### BACKGROUND OF THE INVENTION

Trailers such as car haulers, utility trailers, landscape trailers, enclosed trailers, and travel trailers have trailer jacks near the hitch. These jacks are used for raising and lowering the trailer onto and off of the tow vehicle. The post (or leg) portion of the jack that extends towards to ground for raising the trailer and retracts upwards when the trailer lowered and attached to the tow vehicle. When these trailer jack legs are fully retracted, they very often do not retract to a sufficient height to keep the still partially exposed leg from scraping the ground or pavement during transport, especially over uneven terrain and through steeply pitched driveway transitions.

This scraping of the leg when the tow vehicle and trailer is underway often results in damage to the trailer jack to the point of being inoperable. The scraping of the leg additionally causes damage to the pavement.

The present invention solves this problem by being bolted or welded in between the trailer frame and the trailer jack, thus raising the lowest point of the trailer jack leg by the thickness of the spacer. The height of the spacer can be constructed in a multitude of thicknesses as needed by the end user, typically being constructed by the manufacturer in heights of either 1″, 2″, 3″ or 4″ as these have been determined to be spacing distances that provide appropriate clearances for various trailers.

### SUMMARY OF THE INVENTION

The disclosed exemplary embodiments provide a device that relocates a trailer jack upward, providing additional ground clearance. Therefore, the likelihood of the jack to be damaged, and the for the jack leg to cause damage to property are both reduced. Thus, costly and repetitive replacement of broken trailer jacks can be prevented.

### BRIEF DESCRIPTION OF DRAWINGS

In the following detailed portion of the present description, the teachings of the present application will be explained in more detail with reference to the example embodiments shown in the drawings, in which:

FIG. 1 is an isometric view of the invention showing its placement between a trailer jack and trailer frame according to a first embodiment,

FIG. 2 is an enlarged isometric view of the invention according to a second embodiment, and

FIG. 3 is an enlarged isometric view that additionally shows the bottom of the invention according to a third embodiment, and

FIG. 4 is a top view of the invention according to a fourth embodiment, and

FIG. 5 is a side view of the invention according to a fifth embodiment, and

FIG. 6 is an isometric top view of the invention according to a sixth embodiment.

### DETAILED DESCRIPTION OF THE INVENTION

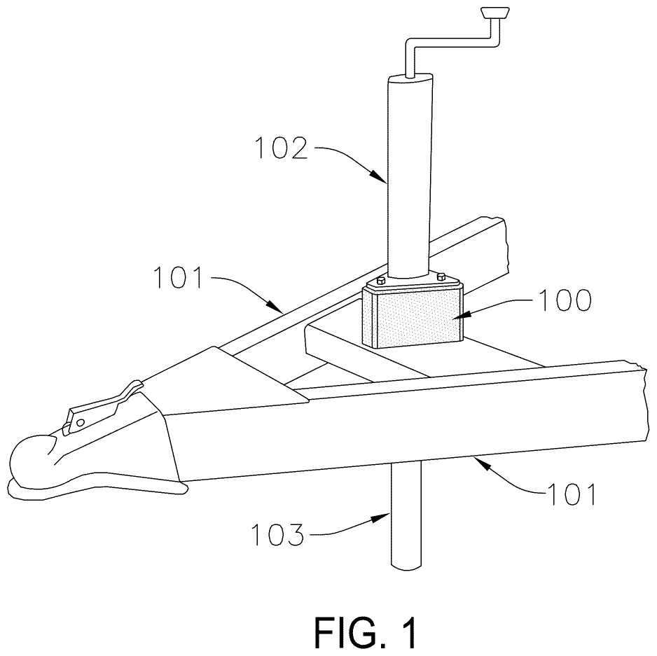

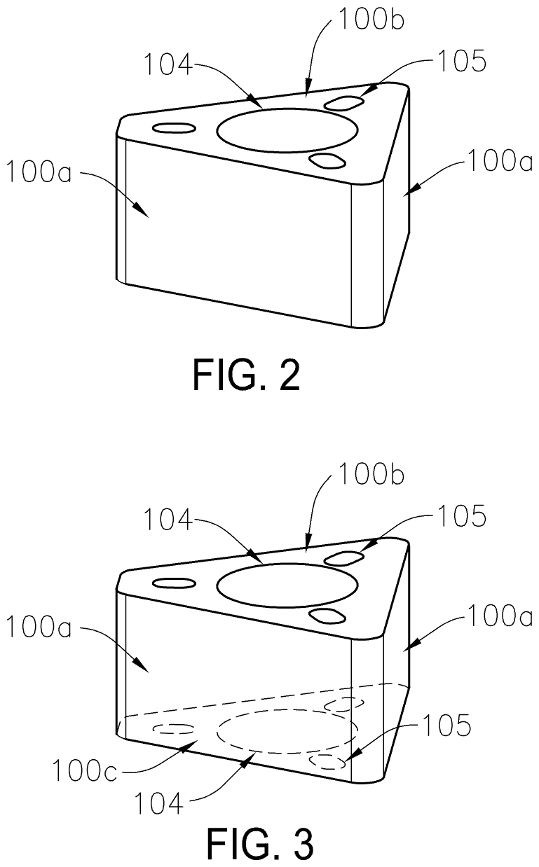

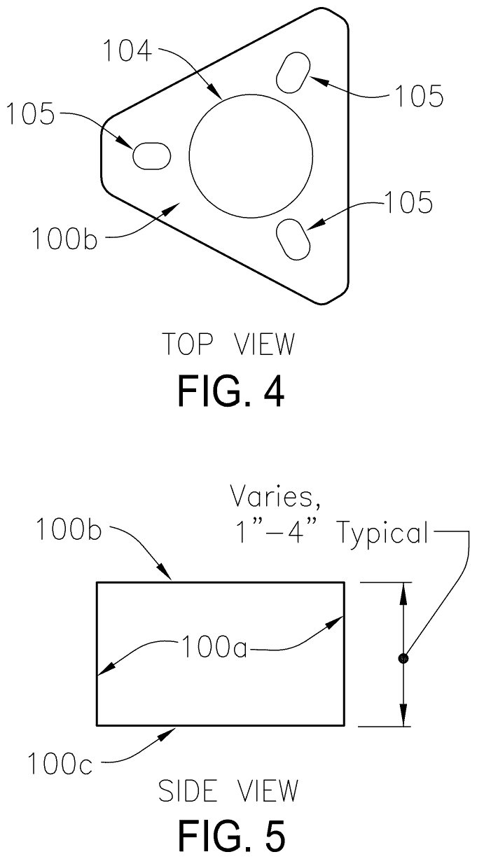

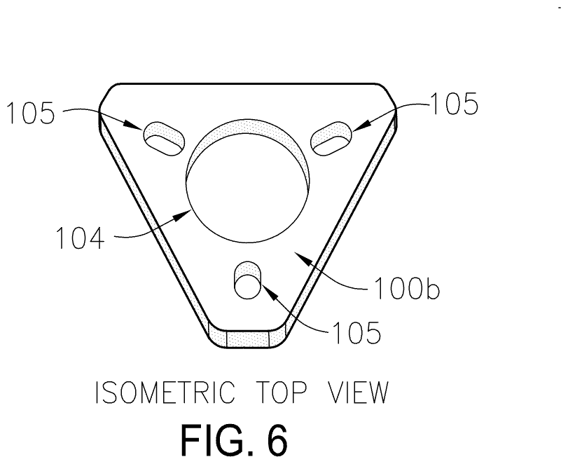

In the following detailed description, the device according to the teachings for this application in the form of a trailer jack spacer will be described by the embodiments. It should be noted that although a metal trailer spacer is described, the teachings of this application can also be used in any other material such as wood, plastic, High Density Poly Ethylene (HDPE) and other materials capable of withstanding the forces applied by a trailer and trailer jack while in use. A first embodiment of the Trailer Jack Spacer 100 is illustrated in FIG. 1. The spacer 100 is inserted between the trailer frame 101 and the trailer jack 102, thus raising the height of the trailer jack extendable leg 103 in relation to the ground. A second embodiment of the Trailer Jack Spacer 100 is illustrated in FIG. 2. The spacer is comprised of, at a minimum, sides 100a, a top 100b. It should be noted that although a bottom component as embodied in FIG. 3 100c is described in the teachings of this application, the spacer may also be constructed in such a manner as to not require the bottom 100c element and still be a viable trailer jack spacer. Sides 100a are of a variable height, as needed to achieve the additional ground clearance desired by the user. It should be noted although the described teachings of this application embody an overall height variable of between one inch and four inches, as determined to be the practical range, and labeled as such in FIG. 5, the teachings of this application are such that there is no minimum or maximum overall spacer height or thickness. A third embodiment of the Trailer Jack Spacer 100 is illustrated in FIG. 3. The present embodiment of the Spacer top 100b and the Spacer bottom 100c (if a bottom component is utilized) comprises of a hole in the middle 104 for the trailer jack 102 to pass through. It should be noted that the minimum or maximum diameter of the hole 104 is not described as a specific dimension since it only need be sized such that it is large enough for the trailer jack 102 to pass through and small enough so the structural integrity and chosen method of attachment is not compromised. Additionally, the present embodiment of the Spacer top 100b and Spacer bottom 100c is illustrated as a triangular shape, however the teachings of this application encompass shapes other than triangular such as cylindrical, oblong, elliptical, square, and rectangular being that many shapes as noted or not noted are able to achieve the same result, being a device that spaces the trailer jack 102 farther away from the trailer 101. If the method of attachment is via bolts, the top 100b and bottom 100c (if utilized) shall have holes 105 allowing for longer bolts to replace the stock bolts so the trailer jack, trailer jack spacer, and trailer may all be connected. It should be noted although the described teachings of this application embody bolt holes that are elongated 105, the size and shape of the holes are not specific and may be of any size and shape that allows for the attachment of the device and this embodiment is incorporated as such. A fourth embodiment of the Trailer Jack Spacer top 100b is illustrated in FIG. 4. The present embodiment of the Spacer top 100b is provided for further clarification of the hole opening 104 for the trailer jack to pass through and the bolt holes 105 for the attachment bolts (if used) to pass through. A fifth embodiment of a Trailer Jack Spacer side 100a is illustrated in FIG. 5. The present embodiment of the Spacer sides 100a comprises of a component of the device that is of a non-specified height, with the option to be constructed of various heights as needed by the end user. A sixth embodiment of the Trailer Jack Spacer top 100a is illustrated in FIG. 6. The present embodiment of the Spacer top 100b is provided to reflect that the top 100b, whether it be a component in the construction of the device or the device in its entirety is of a non-specified thickness, needing only to be of minimum height to be useful to the end user and of maximum height as is practical for the normal operation of a trailer and jack.

### ADVANTAGES OF THE INVENTION

An advantage of the teaching of this application is it provides a device that makes a trailer jack less vulnerable to damage from contacting the ground when the trailer is underway. It is another advantage of the present invention that it makes a trailer jack less likely to cause damage to pavement from scraping the pavement when the trailer is underway. It is another advantage of the present invention that by raising the height of the trailer jack, and likewise the trailer jack handle, it is easier to reach and operate, lessening the need to bend over as far as is necessary without the device. Yet another advantage of the present invention is that the mounting location of some trailer jacks on trailers is such that when the trailer is hitched to a truck, the truck tailgate does not have sufficient clearance from the trailer jack handle to fully open. It has been observed that by raising the mounting location with the device, that the needed clearance can be obtained, thus making the operation of the tow vehicle tailgate much more functionable and it eliminates the possibility of the tailgate being damage by hitting the jack or jack handle.

The present invention is an improvement to the operating efficiency and longevity of trailer jacks in the configurations and mounting locations as currently provided for by the common trailer manufacturers and methods. The present device provides additional improvement by allowing trailer owners a way to easily customize their trailer to more specifically meet their needs.

### METHODS OF ATTACHMENT AND CONSTRUCTION

In the following description, the device according to the teachings for this application, the method of attachment of the spacer is most commonly by utilizing the existing trailer jack mounting holes and simply replacing the stock bolts with longer bolts that go through the jack, the spacer, and then the trailer. This allows for the installation to be performed by the average trailer owner, although welding the spacer to the trailer frame and trailer jack is a viable option and is incorporated as such. In the following detailed description, the device according to the teachings for this application may be constructed by assembly (typically welding) of individual pieces to achieve the final shape although construction may also utilize metal forming equipment that stamps and folds the metal to the desired shape and height and is incorporated herein.

Whilst endeavoring in the foregoing specifications to draw attention to those features of the invention believed to be of particular importance it should be understood that the Applicant claims protection in respect to any patentable feature or combination of features hereinbefore referred to and/or shown in the drawings whether or not particular emphasis has been placed thereon. The term “comprising” as used in the claims does not exclude other elements or steps. The term “a” or “an” as used in the claims does not exclude a plurality. A unit or other means may fulfill the functions of several units or means recited in the claims.

The invention claim is:

1. A device that relocates a trailer jack upward from its original mounting location on a trailer frame.

2. A device according to claim 1, wherein comprising of a trailer jack mounting surface that is flat on top and has sides (of variable height) for the purpose of raising the effective height of a trailer jack on a trailer.

3. A device according to claim 1, wherein comprising of a trailer jack mounting surface that is flat on top and has sides (of variable height) and a bottom component, for the purpose of raising the effective height of a trailer jack on a trailer.

4. A device according to claim 1 that is a metal spacer between a trailer jack and a trailer frame.

5. A device according to claim 1 that is a spacer between a trailer jack and a trailer frame comprised of a material other than metal such as wood, plastic, or High Density Poly Ethylene (HDPE).

6. A device according to claim 1 that is a spacer between a trailer jack and a trailer frame with bolts that go through the trailer jack, trailer jack spacer, and trailer frame as a means of attachment.

7. A device according to claim 1 that is a spacer between a trailer jack and a trailer frame which uses welding as a means of attachment.

8. A device according to claim 1 for which to relocate a trailer jack, which sides may be constructed in a multitude of heights or thicknesses so as to obtain the desired additional clearance from a trailer jack leg to the ground.

9. A device according to claim 1 which is inserted between a trailer and a trailer jack that effectively raises the height of the trailer jack in relation to the trailer frame.

10. A device according to claim 1 which is inserted between a trailer and a trailer jack that effectively raises the height of the trailer jack leg in relation to the ground.
